(19) United States
(12) Patent Application Publication
(10) Pub. No.: US 2009/0287582 A1
(43) Pub. Date: Nov. 19, 2009

(54) DEPLOYING SOFTWARE ITEMS FROM SOFTWARE SHOPPING CARTS ONTO MOBILE WIRELESS DEVICES

(76) Inventors: Badri Nath, Edison, NJ (US); Rakesh Kushwaha, Marlboro, NJ (US)

Correspondence Address: Hanify & King Professional Corporation, 1055 Thomas Jefferson Street, NW, Suite 400, WASHINGTON, DC, 20007, US

(21) Appl. No.: 12/121,723

(22) Filed: May 15, 2008

(51) Int. Cl. G06Q 30/00

(52) U.S. Cl. 705/26

(57) ABSTRACT

Software/content for a mobile device may be selected by means of the web using a device other than the mobile device, and the software/content is downloaded onto the mobile device. This provides the capability to interact with an e-commerce site using some other terminal, such as desktop or laptop computer, and to install the software/content over the air to a given mobile device. This provides improved convenience in the selection and purchase of software/content, as desktop and laptop computer systems typically have which have larger screens and higher speed connectivity than smaller mobile devices.

### BACKGROUND OF THE INVENTION

1. Field of the Invention

The present invention relates to a system, method, and computer program product for deploying software/content items from software/content shopping carts onto mobile wireless devices.

2. Description of the Related Art

The Internet is being used as a vehicle for conducting electronic commerce. Using techniques supported by the World Wide Web, users can choose goods and services for purchase. In most cases, goods are chosen by connecting to an electronic commerce site that is owned by an entity that stocks the goods or is capable of delivering the goods. The selected are entered into a repository commonly known as a shopping cart. Then, based on the site, steps to purchase the goods need to be taken and after completing the process the selected goods are shipped to the address provided by the user.

This process of e-commerce transactions is tailored to purchase goods and services using the World Wide Web. Each merchant provides a web interface through which the items available for sale can be viewed, selected and ordered after making the necessary payments. The transactions may involve physical goods, such as books, appliances, DVDs, etc., which may be shipped separately. In addition, non-tangible goods such as software/content can also be purchased using a computer and downloaded onto the computer. Typically, the software/content is installed on the machine from which the transaction was initiated. Likewise, it is possible to purchase software/content using a wireless mobile device. However, due to the size of the display and keyboard of typical mobile devices, mobile devices do not always offer the best interface with which to interact with an e-commerce site.

Thus, a need arises for a mechanism by which the software/content for a mobile device may be selected by means of the web using a device other than the mobile device, and the software/content is downloaded onto the mobile device.

### SUMMARY OF THE INVENTION

The present invention provides a mechanism by which software/content for a mobile device may be selected by means of the web using a device other than the mobile device, and the software/content is downloaded onto the mobile device. This mechanism makes it possible to interact with an e-commerce site using some other terminal, such as desktop or laptop computer, and provides a mechanism for the software/content to be installed over the air on a given mobile device. This provides improved convenience in the selection and purchase of software/content, as desktop and laptop computer systems typically have which have larger screens and higher speed connectivity than smaller mobile devices.

A software/content delivery system for mobile devices provides the capability for customers to select various software/content components onto a web shopping cart and select a mobile device onto which the items in the shopping cart are to be deployed. A customer interacts with a plurality of servers to select software/content for a mobile wireless device. The selected software/content is attached to a software/content shopping cart associated with a phone number or some other identifier unique to the mobile device. Then, the software/content delivery system takes action to deploy the software/content items in the shopping cart onto the mobile devices identified by the phone number or any other unique identifier of the mobile device.

For example, a method provides the capability to associate a mobile device to a web shopping cart for the purposes of deploying software/content selected in the shopping cart onto the said mobile device.

As another example, a method provides the capability to associate an identity of the mobile device with the shopping cart. The identity could be, for example, a phone number, an Electronic Serial Number (ESN), an International Mobile Equipment Identity (IMEI), or any other identifier that uniquely identifies the device. The identity of the mobile device is used to set up a session with the mobile device for the purpose of deploying the software/content items in the shopping cart.

In addition, the user is enabled to select software/content from a server such as a device management server, a content server, or an e-commerce server, and then the selected items are deployed onto the mobile device. A further step may include payment for the software/content item. This mechanism enables the user to connect to the server from any host, different from the mobile host, to direct that the software/content be downloaded on to the mobile device.

Further, the server may check compatibility of the selected software or content with the mobile device. This may include determining the make and model of the mobile device from its identity and/or the firmware of the mobile device, checking the software/content version and requirements, and deselecting the software/content item if found not compatible.

In addition, a software/content catalog may be maintained by the server that provides the prerequisites for installing the software/content on a mobile device. This catalog may be used by a program that checks for compatibility prior to the deployment of the software/content in the shopping cart to the mobile device.

Likewise, software/content downloaded from the shopping cart onto the mobile device may be optionally installed and activated on the mobile device. The device may be configured to use an agent to receive commands from the server to install and activate the downloaded software/content from the shopping cart. The deploy method in the server may be configured to allow for just download of the software/content from the shopping cart, or download and install from the shopping cart or download, install, and activate from the shopping cart.

Further, a method may be provided by which the selected items from the shopping cart may be deployed on multiple devices, where the program checks for the compatibility of the software/content with each device before deploying it over a wireless link.

In addition, a method may be provided to establish a data session with the mobile device for the purposes of downloading software/content from the shopping cart. The method may include the selection of the software/content item in the shopping cart, establishing a session with the mobile device and deploying the software/content item on the mobile device. The method steps are repeated for each of the software/content item in the shopping cart associated with the device.

### BRIEF DESCRIPTION OF THE DRAWINGS

Further features and advantages of the invention can be ascertained from the following detailed description that is provided in connection with the drawings described below:

FIG. 1 is a high-level block diagram of the system in which the present invention is implemented.

FIG. 2 is a high-level illustrative diagram of the system in which the present invention is perceived by the user.

FIG. 3 is a block diagram showing the support components of the system

FIG. 4 is a flowchart of the method used in on-line selection of software/content that needs to be deployed on mobile devices.

### DETAILED DESCRIPTION OF THE PREFERRED EMBODIMENTS

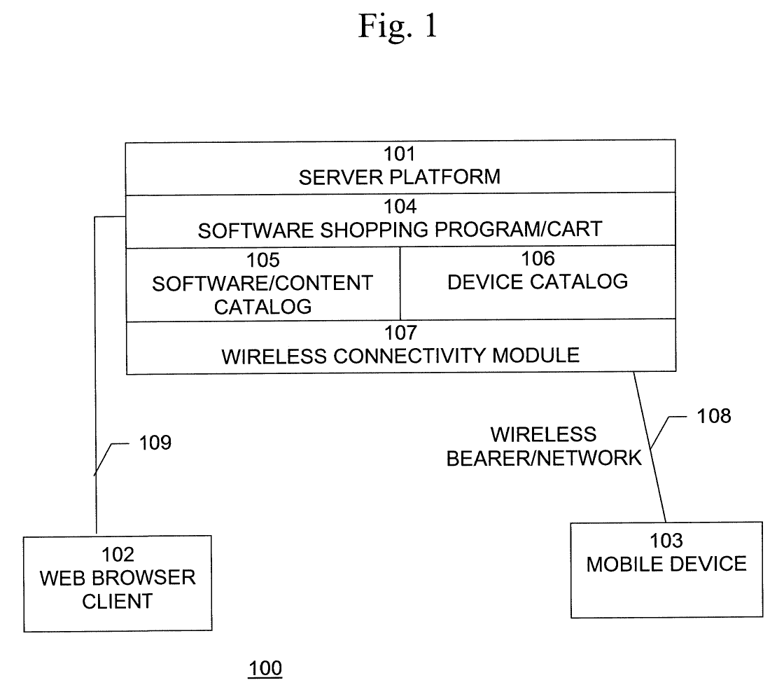

FIG. 1 is an exemplary block diagram of a system 100 in which the present invention may be implemented. System 100 includes a server platform 101, a client machine 102 with a web browser, and a mobile device 103. A customer using any client machine 102 with a web browser can connect to the server platform 101 which hosts the desired software/content. Client machine 102 connects to server 101 over a network 109, such as the Internet, or any public or private communications network. Server 101 hosts programs that implement and maintain a software/content shopping program/cart 104, a software/content catalog 105, a device catalog 106, and a wireless connectivity module 107. Software/content shopping program/cart 104 provides the capability for a customer using client machine 102 with a web browser to browse, search, select and purchase a variety of software/content items that are to be deployed, loaded, or installed on mobile device 103. Software/content catalog 105 provides storage for the various software/content items that may be deployed onto mobile wireless devices, as well as information relating to the requirements needed to install the software/content items on particular mobile devices. Software/content catalog 105 may include a variety of versions of software/content items, such as versions designed for particular makes and models of mobile devices. Device catalog 106 is a database that provides a mapping between a unique identifier of a device to a make and model of the device. The unique identifier may be a phone number, an Electronic Serial Number (ESN), an International Mobile Equipment Identity (IMEI), or any other identifier that uniquely identifies the device. Wireless connectivity module 107 provides the capability for server 101 to connect to the mobile device 103 using any suitable wireless bearer or network 108. Examples of such wireless bearers include Global System for Mobile communications (GSM), General Packet Radio Service (GPRS), a wireless local area network (WLAN or Wi-Fi), Worldwide Interoperability for Microwave Access (WiMAX), Evolution-Data Optimized or Evolution-Data only (EVDO), Third Generation Partnership Project Long Term Evolution (3GPP-LTE or LTE) Bluetooth, and Code Division Multiple Access (CDMA), or any other wireless bearer or network that may be supported by a mobile wireless device 103.

Typically, server 101 directly initiate a data session using wireless bearer or network 108, with which the server can deploy software/content on mobile device 103. Server 101 may also use capabilities such as SMS (short messaging service) or IP (Internet protocol) to notify mobile device 103 to initiate a data session with server 101 for the purposes of deploying software/content. Thus, server 101 includes a set of server functionality that enables server 101 to establish a data connection with the mobile wireless device. As shown in FIG. 1, the server functionality also includes an interface, such as the software/content shopping cart 104, which can be associated with a unique identity on the mobile device. Once the software/content is selected and the mobile device 103 is identified, the software programs resident on the server 101 uses the wireless connectivity module 107 to deploy the software/content from server 101 onto wireless mobile device 103.

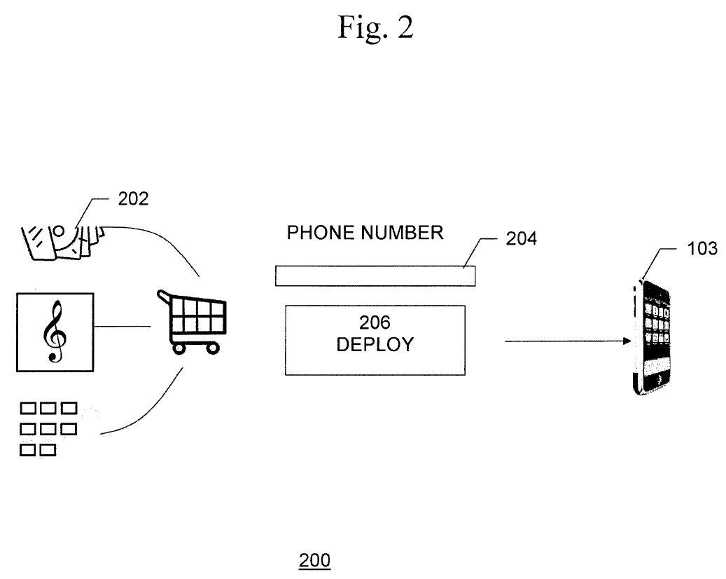

A customer may be a user who has access to the Internet or other network that provides connectivity to server 101. The customer connects to server 101, which provides a software/content deployment service that uses the various aspects of the present invention. FIG. 2 is an exemplary diagram of a user interface 200 implemented by software/content shopping program/cart 104, shown in FIG. 1, which may be seen and used by the customer. Software/content shopping program/cart 104 displays a variety of software/content items 202 to the customer. Using software/content shopping program/cart 104, the customer may browse, search, and select software/content items to be deployed to mobile device 103. The software/content items may be listed in a catalog or other means by which the user may identify and select the desires software/content. The software/content may include application software, software updates, content such as audio, images, video, or any such entity that can be downloaded and installed on mobile wireless device 103.

User interface 200 also provides a mechanism for the customer to associate one or more particular mobile devices 103 with software/content shopping program/cart 104. The mechanism may be as simple as a box 204 in which the customer may enter a phone number of the mobile device 103, or the mechanism may be more complex. For example, software/content shopping program/cart 104 may use a database of mobile devices 103 that are associated with a particular customer based on the login id of the customer. Any mechanism by which one or more particular mobile devices 103 may be associated with software/content shopping program/cart 104 may be used.

Once a mobile device 103 is associated with software/content shopping program/cart 104, the customer may select the desired software/content items. Additional steps such as paying for the software/content and verifying the credentials of the customer by means of a password or some other means may be taken. In other cases, a service provider or wireless operator can use the functionality of the present invention to select software/content and deploy it on the mobile wireless device 103. In such a case, additional steps such as payment may be handled by a separate process. In any case, the customer, after attaching a device or groups of devices to the shopping cart, selects the desired software/content items and uses the deploy button 206 to download the selected software/content onto the desired mobile wireless devices.

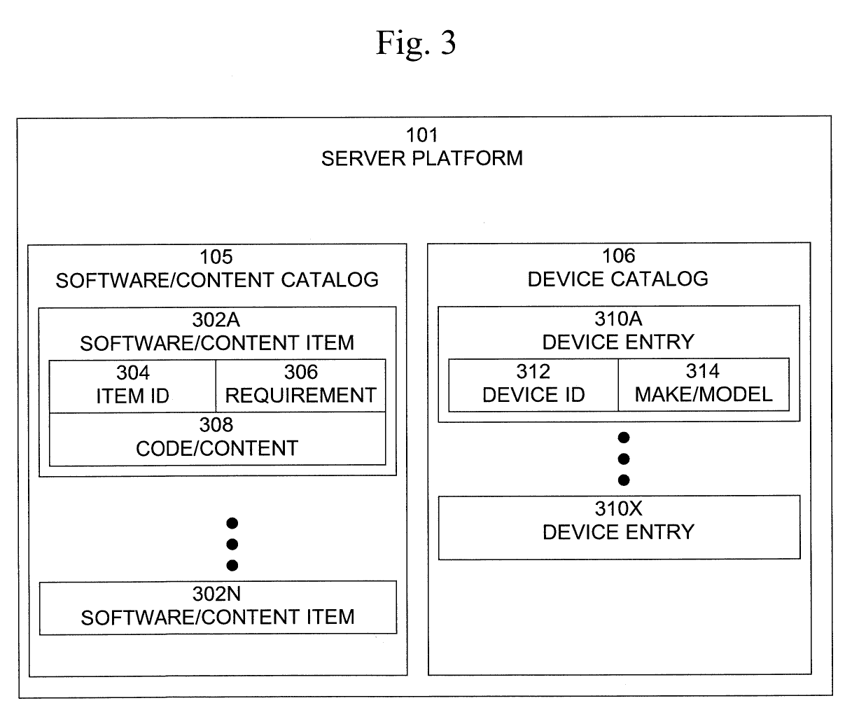

Wireless devices support different operating systems and different hardware capabilities. Factors such as the version of the operating system, the hardware supported, such as memory size, and firmware capabilities determine whether a given version of the software/content can be deployed on a mobile device. An example of information maintained by the server to determine if the selected software/content can be deployed on a particular device is shown in FIG. 3. The mapping contains two catalogs. Software/content catalog 105 provides storage for the various software/content items that may be deployed onto mobile wireless devices, as well as information relating to the requirements needed to install the software/content items on particular mobile devices. For each software/content item 302A-N listed on server 101, information identifying the software/content item 304, information specifying the requirements 306 to deploy the software/content item, and the code/content of the software/content item are stored. Requirement information 306 typically includes an encoding that specifies information such as the required operating system, firmware version and the hardware requirements for the software/content item.

The second catalog is the device catalog 106, which stores a plurality of device entries 310A-X, each of which includes a mapping between the identity of the device 310, such as the phone number, to the make and model of the device 314 associated with the identifier. This mapping may be obtained by an external entity and stored in the deployment server or can be dynamically obtained by querying the device for the details of the device.

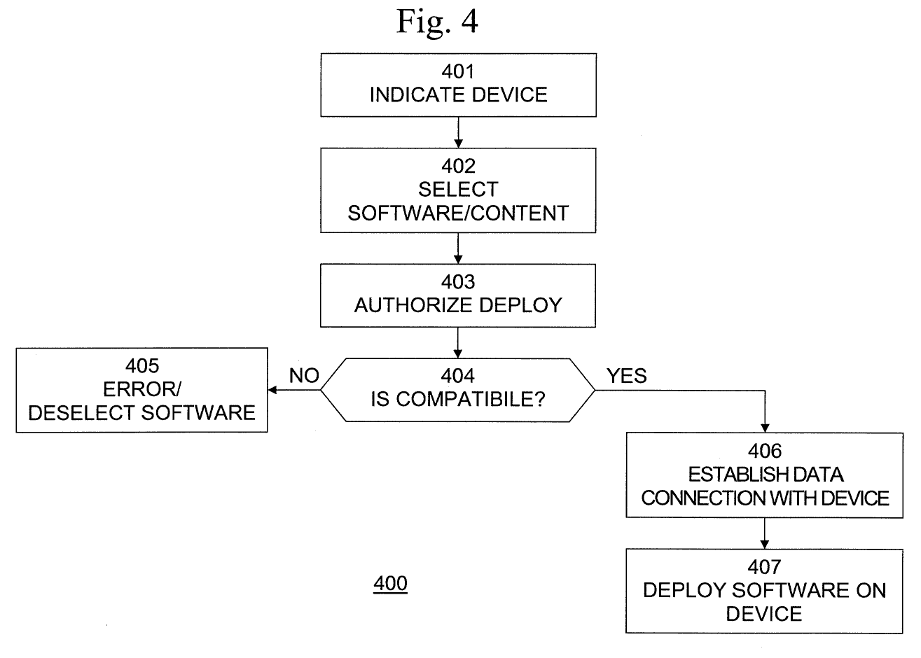

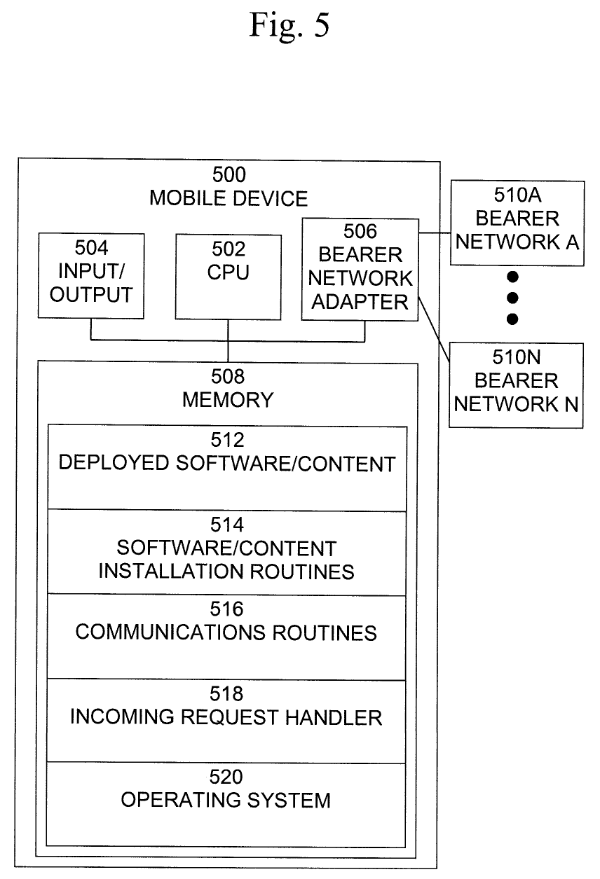

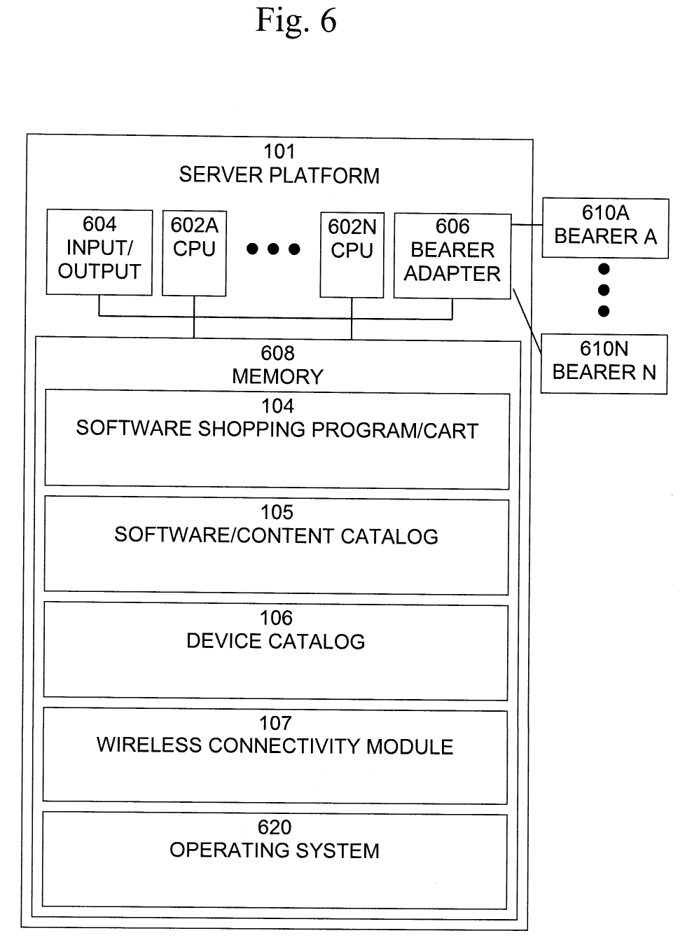

FIG. 4 is an exemplary flow chart of a process 400 of selecting software/content items for a given mobile device. The process begins with step 401, in which a customer indicates or selects a mobile device onto which the software/content is to be deployed. Typically, a customer may indicate this information by entering a phone number or other identifier of a mobile device, or select a mobile device from a list, etc. In step 402, the customer selects the software/content that will be deployed on the device. In step 403, authorization or security checks may be performed to ensure that the indicated device belongs to the customer who wants to deploy the software/content and that the customer is authorized to deploy the software/content onto the device. In step 404, using the software/content catalog and the device catalog, the compatibility of the selected software/content items is checked with that of the make and model of the mobile device. If the compatibility check fails, then in step 405, the software/content is deselected from shopping cart. At this point the customer is free to choose any other software/content item that may be compatible with the device. If the compatibility check succeeds, then in step 406, the server establishes a data connection with the mobile device and, in step 407, deploys the selected software/content to the device. The deploy step may involve actually installing the software/content on the device. This may be accomplished by sending commands to a software/content installer on the device that can install the software/content on the device.

For purposes of the deploying the software/content on the device, the server must establish a data connection session. There are at least two ways of establishing a data session with the device. One approach is the use of a notification message that can be sent to the device using SMS or IP. Upon receipt of the notification message, the mobile device will connect to the server and receive the software/content to be deployed. In the second approach, the server can directly establish a connection with a device, if the device is willing to accept a data session from a server. In this case, a web server or listener should be operational on the device so that incoming requests for data sessions can be handled.

The Internet has become the platform of choice for conducting e-commerce transactions. Users can connect to a web server and select and purchase items that are delivered to the house or an address specified in the transactions. The present invention is a method by which a software/content shopping cart is used to select software/content that is to be deployed on the mobile devices. The embodiments of the inventions allow for the shopping cart to be associated with a mobile wireless device so that compatible software/content can be deployed on the mobile wireless device. Further, the present invention contemplates that software/content items can be deployed to multiple devices by associating the identity of the each of the devices with the shopping cart.

An exemplary block diagram of a mobile device 500 in which the present invention may be implemented is shown in FIG. 5. Device 500 is typically a wireless communication and/or computation device, such as a mobile phone, personal digital assistant, personal computer, and the like. Device 500 includes processor (CPU) 502, input/output circuitry 504, network adapter 506, memory 508, and mass storage 510. CPU 502 executes program instructions in order to carry out the functions of the present invention. Typically, CPU 502 is an embedded microprocessor, such as an INTEL PENTIUM® processor, but may also be a microcomputer or other embedded processing device. Although in the example shown in FIG. 5, device 500 is a single processor system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which device 500 is implemented on a plurality of networked computer systems, which may be single-processor computer systems, multi-processor computer systems, or a mix thereof.

Input/output circuitry 504 provides the capability to input data to, or output data from, device 500. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 506 interfaces device 500 with at least one bearer network 511A-N. Bearer networks 511A-N may be any standard bearer network or WLAN, such as GSM, GPRS, EVDO, WiMAX, LTE, Wi-Fi, CDMA, etc., or any private or proprietary bearer network.

Memory 508 stores program instructions that are executed by, and data that are used and processed by, CPU 502 to perform the functions of the present invention. Memory 508 may include volatile memory, including electronic memory devices such as random-access memory (RAM), and non-volatile memory, including electronic memory devices such as read-only memory (ROM), programmable read-only memory (PROM), electrically erasable programmable read-only memory (EEPROM), flash memory, etc. Memory 508 may also include mass storage that provides the capability to store large amounts of information, such as program instructions and data, in a persistent and accessible form. Mass storage typically includes electromechanical storage devices, such as magnetic disk drives, tape drives, optical disk drives, etc., which may use an integrated drive electronics (IDE) interface, or a variation or enhancement thereof, such as enhanced IDE (EIDE) ultra direct memory access (UDMA), or Serial Advanced Technology Attachment (SATA), or a small computer system interface (SCSI) based interface, or a variation or enhancement thereof, such as fast-SCSI, wide-SCSI, fast and wide-SCSI, etc, or a fiber channel-arbitrated loop (FC-AL), etc. Mass storage may also include electronic memory devices, which are typically non-volatile devices, such as those described above, but which also may be volatile memory devices.

Memory 508 includes deployed software/content 512, software/content installation routines 514, communications routines 516, incoming request handler 518, and operating system 520. Deployed software/content 512 includes software and/or content that has been, or is being deployed on mobile device 500. Some deployed software/content 512 may be pre-loaded on mobile device 500, while other deployed software/content 512 may be loaded later, such as using the processes described above. Deployed software/content 512 may include applications that provide functionality to device 500 and may include applications that interact with a user of the device, applications that communicate and/or process information, and any other type of application. Deployed software/content 512 may also include information that is read, processed, and stored by such applications, such as software updates, content such as audio, images, video, and the like. Software/content installation routines 514 provide the capability to install and activate deployed software/content 512 as described above. Communications routines are software routines that are typically used by applications 512 to communicate information to and from device 500. Incoming request handler 518 provides the capability to accept a data session from a server, and may include a web server or listener routines, so that incoming requests for data sessions can be handled. Operating system 520 provides overall system functionality.

An exemplary block diagram of a server platform 101, such as that shown in Fig. a, is shown in FIG. 6. Server 101 is typically a programmed general-purpose computer system, such as a personal computer, workstation, server system, and minicomputer or mainframe computer. Server 101 includes one or more processors (CPUs) 602A-602N, input/output circuitry 604, network adapter 606, and memory 608. CPUs 602A-602N execute program instructions in order to carry out the functions of the present invention. Typically, CPUs 602A-602N are one or more microprocessors, such as an INTEL PENTIUM® processor. FIG. 6 illustrates an embodiment in which Server 101 is implemented as a single multi-processor computer system, in which multiple processors 602A-602N share system resources, such as memory 608, input/output circuitry 604, and network adapter 606. However, the present invention also contemplates embodiments in which server 101 is implemented as a plurality of networked computer systems, which may be single-processor computer systems, multi-processor computer systems, or a mix thereof.

Input/output circuitry 604 provides the capability to input data to, or output data from, database/server 101. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 606 interfaces server 101 with a plurality of bearer networks 610A-N. Bearer networks 610A-N may be any standard bearer network or WLAN, such as GSM, GPRS, EVDO, WiMAX, LTE, Wi-Fi, CDMA, etc., or a private or proprietary bearer network.

Memory 608 stores program instructions that are executed by, and data that are used and processed by, CPU 602 to perform the functions of server 101. Memory 608 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 608 varies depending upon the function that server 101 is programmed to perform. In the example shown in FIG. 6, memory contents that would be included in Web server 106, search engine 108, and recommendation system 110 are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 6, memory 608 includes software/content shopping program/cart 104, software/content catalog 105, device catalog 106, wireless connectivity module 107, and operating system 620. Software/content shopping program/cart 104 provides the capability for a customer using client machine 102 with a web browser to browse, search, select and purchase a variety of software/content items that are to be deployed, loaded, or installed on mobile device 103. Software/content catalog 105 provides storage for the various software/content items that may be deployed onto mobile wireless devices, as well as information relating to the requirements needed to install the software/content items on particular mobile devices. Software/content catalog 105 may include a variety of versions of software/content items, such as versions designed for particular makes and models of mobile devices. Device catalog 106 is a database that provides a mapping between a unique identifier of a device to a make and model of the device. The unique identifier may be a phone number, an Electronic Serial Number (ESN), an International Mobile Equipment Identity (IMEI), or any other identifier that uniquely identifies the device. Wireless connectivity module 107 provides the capability for server 101 to connect to the mobile device 103 using any suitable wireless bearer or network 108. Operating system 620 provides overall system functionality.

As shown in FIG. 6, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for purchasing and deploying software over the air onto a mobile device, comprising:
associating a mobile device with a shopping cart;
displaying, to a device other than the mobile device that is associated with the shopping cart, software and content for selection;
receiving, in the shopping cart, a selection of software and content from among the displayed software and content;
selecting for deployment only that software and content in the shopping cart that is compatible with the mobile device that is associated with the shopping cart; and
deploying the compatible software contained in the shopping cart to the mobile device by transmitting the software over the air to the mobile device.

2. The method of claim 1, wherein a plurality of mobile devices are associated with the software shopping cart

3. The method of claim 1, wherein the compatibility of the selected software is determined based on a make and model of the mobile device which is determined based on a unique identifier associated with the mobile device.

4. The method of claim 3, wherein the compatibility of the selected software is further based on a current version of firmware of the mobile device.

5. The method of claim 3, wherein, when selected software is determined not to be compatible with the mobile device, the selected software is removed from the shopping cart.

6. The method of claim 1, wherein the software in the shopping cart is deployed to the mobile device by downloading the software over the air from a server hosting the shopping cart to the mobile device.

7. The method of claim 6, wherein the software downloaded to the mobile device is installed on the mobile device by a command sent from the server to the mobile device.

8. The method of claim 7, wherein the software installed on the mobile device is activated by a command sent from the server to the mobile device.

9. The method of claim 8, where the command to install the software on the mobile device is received by a software program that installs the downloaded software on the mobile device.

10. The method of claim 9, where the command to activate the software on the mobile device is received by a software program that activates the installed software on the mobile device.

11. The method of claim 1, wherein the software is transmitted to the mobile device using at least one of: General Packet Radio System (GPRS), Universal Mobile Telecommunication System (UMTS), Code Division Multiple Access (CDMA), Long Term Evolution (LTE), WiMAX, and Wireless LAN.

12. A system for purchasing and deploying software over the air onto a mobile device, comprising:
a server comprising a processor for executing computer program instructions, a memory for storing the computer program instructions executable by the processor, and the computer program instructions stored in the memory and executable to:
associating a mobile device with a shopping cart;
displaying, to a device other than the mobile device that is associated with the shopping cart, software and content for selection;
receiving, in the shopping cart, a selection of software and content from among the displayed software and content;
selecting for deployment only that software and content in the shopping cart that is compatible with the mobile device that is associated with the shopping cart; and
deploying the compatible software contained in the shopping cart to the mobile device by transmitting the software over the air to the mobile device.

13. The method of claim 12, wherein a plurality of mobile devices are associated with the software shopping cart

14. The method of claim 12, wherein the compatibility of the selected software is determined based on a make and model of the mobile device which is determined based on a unique identifier associated with the mobile device.

15. The method of claim 14, wherein the compatibility of the selected software is further based on a current version of firmware of the mobile device.

16. The method of claim 14, wherein, when selected software is determined not to be compatible with the mobile device, the selected software is removed from the shopping cart.

17. The method of claim 12, wherein the software in the shopping cart is deployed to the mobile device by downloading the software over the air from a server hosting the shopping cart to the mobile device.

18. The method of claim 17, wherein the software downloaded to the mobile device is installed on the mobile device by a command sent from the server to the mobile device.

19. The method of claim 18, wherein the software installed on the mobile device is activated by a command sent from the server to the mobile device.

20. The method of claim 19, where the command to install the software on the mobile device is received by a software program that installs the downloaded software on the mobile device.

21. The method of claim 20, where the command to activate the software on the mobile device is received by a software program that activates the installed software on the mobile device.

22. The method of claim 12, wherein the software is transmitted to the mobile device using at least one of: General Packet Radio System (GPRS), Universal Mobile Telecommunication System (UMTS), Code Division Multiple Access (CDMA), Long Term Evolution (LTE), WiMAX, and Wireless LAN.
